(19) United States
(12) Patent Application Publication
(10) Pub. No.: US 2010/0074047 A1
(43) Pub. Date: Mar. 25, 2010

(54) ANTI-ROTATION DEVICE FOR A GRIPPING MEMBER OF A MIXING MACHINE FOR FLUID PRODUCTS CONTAINED IN A CLOSED CONTAINER

(75) Inventors: Fabrizio Benatti, Cavezzo (IT); Andrea Capucci, Mirandola (IT)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: CPS COLOR EQUIPMENT SPA CON UNICO SOCIO, San Felice Sul Panaro (IT)

(21) Appl. No.: 12/526,366

(22) PCT Filed: Feb. 7, 2008
(86) PCT No.: PCT/EP08/51475

§ 371 Date: Dec. 1, 2009

(30) Foreign Application Priority Data
Feb. 8, 2007 (IT) UD2007A000026

(51) Int. Cl. B01F 15/00

(52) U.S. Cl. 366/213

(57) ABSTRACT

An anti-rotation device for a gripping member of a mixing machine for fluid products contained in a closed container. The mixing machine comprises a fixed structure and the gripping member comprises a supporting structure rotary with respect to the fixed structure and on which two gripping elements are mounted, able to be selectively moved nearer to or farther from each other by means of a screw, in order to determine the temporary clamping of the container with respect to the supporting structure. The device comprises clamping members associated coaxially with the screw in order to keep the screw temporarily constrained angularly with respect to the supporting structure of the gripping member, and unclamping members mounted on the fixed structure in order to be selectively moved, so as to cooperate with the screw, so as to de-activate the action of the clamping members and to de-constrain the angular movement of the screw with respect to the supporting structure, and actuation members able to automatically and selectively command both the unclamping members and also the clamping members.

### FIELD OF THE INVENTION

The present invention concerns an anti-rotation device for a gripping member of a mixing machine, able to mix fluid products such as for example coloring liquids, bases for paints, varnishes, glosses, inks or suchlike, contained in a closed container, in order to compose a paint of a determinate color. In particular, the device according to the present invention is applied to the gripping member able to temporarily clamp the container during its rotational mixing movement, in order to prevent the accidental opening of the gripping member during the mixing steps.

### BACKGROUND OF THE INVENTION

Mixing machines are known, also called mixers, able to mix together fluid products, such as for example dyes of different tonality or color, and/or added to a base substance to compose a paint of a determinate color.

These known machines effect the mixing of the fluid products by means of rotational, gyroscopic, orbital, vibratory or other movements, and normally comprise a rotary or vibratory unit, which makes a closed container rotate or oscillate, in which the fluid products to be mixed are contained. The container normally consists of a can, a drum, a barrel or other, according to the quantity of fluid product contained.

In particular, the rotary or vibratory unit comprises a gripping member, able to temporarily clamp the container in a determinate position, and to be made to selectively rotate or oscillate by a drive member.

The gripping member is usually formed by a rotary structure on which a pair of clamping plates are mounted, disposed respectively above and below the container, which plates are mounted by means of bushings on a relative screw element which determines, with its axial rotation, the reciprocal movement thereof nearer to or away from each other.

Due to the rotational or oscillatory movements that take place during the mixing steps, and due to the vibrations that develop, the screw element tends to loosen, that is, to rotate autonomously by some degrees, causing the plates to move reciprocally away from each other, and therefore causing the grip on the container to loosen.

This disadvantage may cause not only a non-optimum mixing of the fluid products, but also the accidental release of the container during the mixing steps, with possible damage, even serious, to the machine and to the workers.

Purpose of the present invention is to achieve an anti-rotation device which, in a completely automated manner, prevents the accidental opening of the plates of the gripping member, during the mixing steps of the fluid products.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

An anti-rotation device according to the present invention is applied to a gripping member of a mixing machine able to mix fluid products contained in a closed container, such as for example a drum, a barrel or suchlike, by means of rotation or oscillation of said container.

The machine comprises a fixed structure and the gripping member comprises a rotary structure on which two gripping elements or clamping plates are mounted, between which the container is temporarily clamped during the mixing steps, which plates are reciprocally moved nearer to or farther from each other by means of screw means.

According to a characteristic feature of the present invention, the anti-rotation device comprises clamping means, for example mechanical, friction, or other, associated coaxially with said screw means, in order to maintain the latter normally constrained angularly with respect to the rotary structure of the gripping member, and unclamping means associated with the fixed structure and able to be moved selectively and in a completely automated manner, to cooperate with the screw means, so as to de-activate the action of the clamping means and thus to allow the angular movement of the screw means with respect to the rotary structure of the gripping member. Advantageously, the clamping and unclamping means are actuated by a substantially mechanical actuation mechanism, commanded electrically. The screw means too is advantageously commanded electrically. An electronic processor is able to control and command said actuation mechanism.

In this way, during the mixing step, the screw means is normally maintained in a position of angular constraint with the rotary structure of the gripping member. Therefore, even if the gripping member is made to rotate or to oscillate, in order to effect the mixing of the fluid products, there is no risk that the screw means can rotate autonomously with respect to the gripping member, thus preventing any unwanted loosening by the clamping plates of their grip on the container.

With the present invention, the screw means is thus normally maintained in an angularly clamped condition, and is unclamped only when the unclamping means is actuated, that is, only in conditions when an individual rotation thereof is necessary, for example to achieve the reciprocal movement of the clamping plates nearer to or away from each other during the loading or unloading step of a container.

Advantageously, the unclamping means is conformed in such a manner that, in an active unclamping condition thereof, it is constrained angularly to the screw means, and connected to a drive member, so as to be able to be made to rotate in one direction or the other. This rotation is transmitted axially to the screw means in its unclamped condition, so as to command the reciprocal movement nearer to or away from each other of the clamping plates.

In a preferential form of embodiment, the movement of the unclamping means is effected by means of a lifting mechanism that is normally used to move a mechanical stop element, of a known type, able to clamp, in a determinate angular inactive position, preferably with the container in a vertical position and its lid facing upwards, the entire gripping member of the machine, at the end of the mixing step.

In another form of preferential embodiment, the clamping means comprises an anti-rotation member mounted coaxial at one end of the screw means, a fixed reference member mounted on the rotary structure and at least an elastic element able to keep the anti-rotation member normally in cooperation with the fixed reference member, in order to constrain angularly the individual rotation of the screw means. In this way, the action of the unclamping means is such as to overcome the force of the elastic element and to separate the anti-rotation member from the fixed reference member, and allow the individual rotation of the screw means.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic view of a lateral section of a mixing machine on which an anti-rotation device according to the present invention is installed, in a first operating condition;

FIG. 2 is an enlarged detail of FIG. 1;

FIG. 3 is a front right section of the detail in FIG. 2;

FIG. 4 shows the detail of FIG. 2 in a second operating condition;

FIG. 5 is a front right section of the detail in FIG. 4;

FIG. 6 is an enlarged detail of the anti-rotation device in FIG. 2;

FIG. 7 shows the detail of FIG. 2 in the second operating condition of FIG. 4;

FIG. 8 is a lateral exploded view of the anti-rotation device shown in FIGS. 6 and 7;

FIG. 9 is a block diagram of the control circuit of the anti-rotation device according to the present invention and of the mixing machine on which it is applied.

### DETAILED DESCRIPTION OF A PREFERENTIAL FORM OF EMBODIMENT

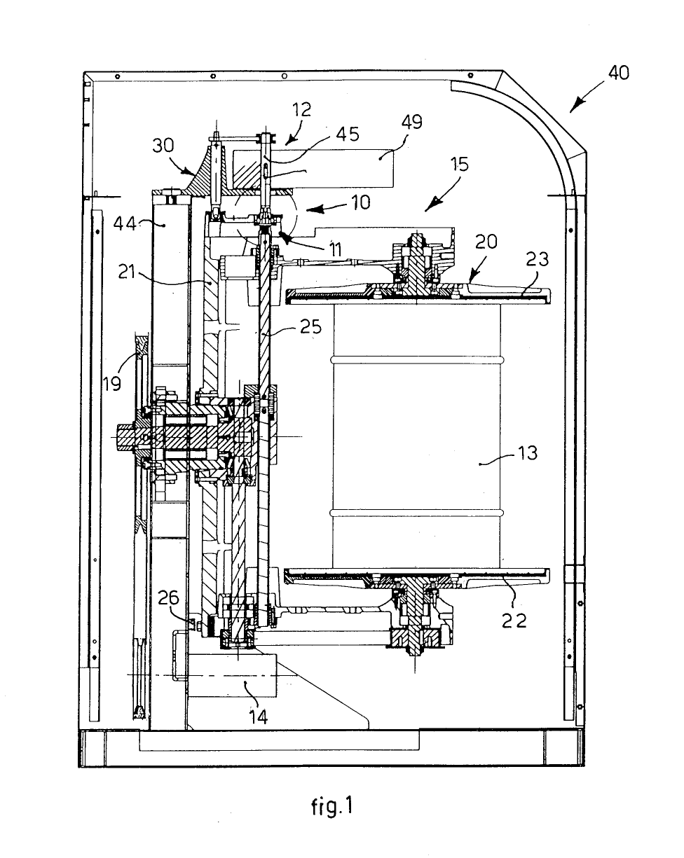

With reference to FIG. 1, an anti-rotation device 10 according to the present invention is shown applied to a gripper mechanism 20 of a rotary unit 15 of a mixing machine 40, able to make a closed container 13 rotate, containing one or more fluid products, in order to mix them.

The container 13 may consist for example of a can, a tin, a drum or other, suitable to contain and preserve coloring liquids, bases for paints, varnishes, glosses, inks or others of determinate color and tonality.

The rotary unit 15 is mounted rotatable on a fixed structure 44 of the mixing machine 40 and is able to be made to rotate by means of a drive pulley 19 connected a first electric motor 14 mounted on a fixed structure 44. The rotary unit 15 comprises a supporting structure 21, also rotary, on which the gripping mechanism 20 is mounted. The latter is able to keep the container 13 clamped with respect to the supporting structure 21 during the mixing cycle.

In this case the gripping mechanism 20 comprises two clamping plates, respectively a lower supporting plate 22 and an upper pressure plate 23, able to be moved reciprocally nearer to or farther from each other, and between which the container 13 is able to be disposed so as to be temporarily clamped between them, in such a manner that it can rotate together with the rigid structure 21.

The reciprocal movement, nearer to or away from each other, of the two plates 22 and 23 is achieved by a screw element 25, which is able to be driven, as will be explained hereafter, in a completely automated manner, by means of a second electric motor 49 mounted on the upper part of the fixed structure 44.

The operation to clamp or unclamp the container 13 by the two plates 22 and 23 takes place when the rotary unit 15 is in a determinate angular position, advantageously vertical, for loading or unloading the container 13. The angular position of the rotary unit 15 is able to be detected by a first position sensor 26, mounted on the fixed structure 44.

The anti-rotation device 10 according to the invention comprises a clamping mechanism 11 able to keep the screw 25 normally constrained angularly with respect to the supporting structure 21, and an unclamping mechanism 12, able to selectively de-activate the action of the clamping mechanism 11, in order to allow the screw 25 to rotate with respect to the supporting structure 21.

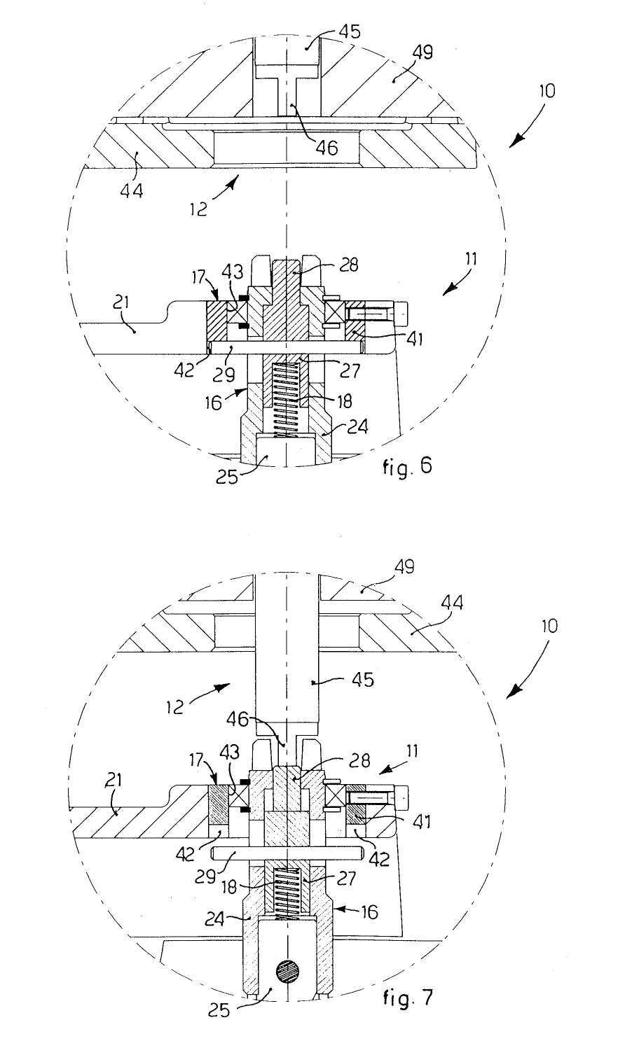

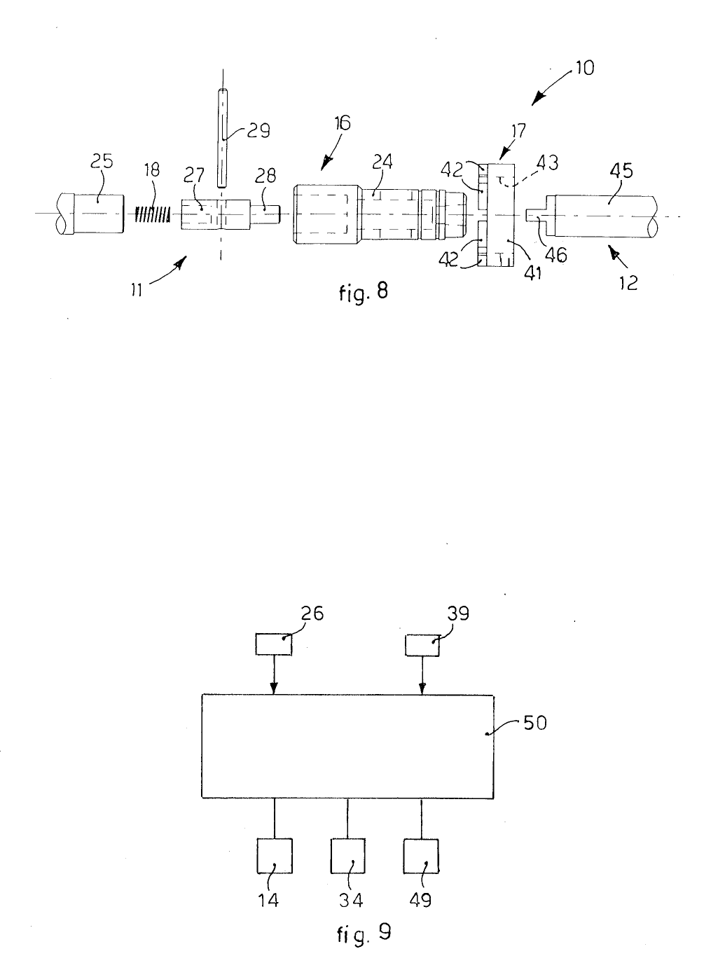

In this case, the clamping mechanism 11 comprises an anti-rotation member 16 (FIGS. 6, 7 and 8), mounted on an upper end of the screw element 25, a reference member 17 mounted angularly fixed on the supporting structure 21, and a helical spring 18 disposed so as to exert an axial thrust on the anti-rotation member 16, in order to keep it normally in contact with the reference member 17.

In particular, the anti-rotation member 16 comprises a hollow cap 24 angularly fixed to the upper end of the screw 25, a slider 27 disposed sliding inside the hollow cap 24 and angularly constrained to the latter. The slider 27 also comprises a terminal portion 28 normally facing towards the outside, through an upper aperture of the hollow cap 24.

The anti-rotation member 16 also comprises a clamping pin 29 mounted transversely on the slider 27, and having the respective ends protruding sideways from the hollow cap 24. This disposition of the clamping pin 29 determines the angular constraint between the slider and the hollow cap 24.

The helical spring 18 in this case is positioned inside the hollow cap 24 and is interposed between the screw 25 and the slider 27, so as to thrust the latter axially upwards.

The reference member 17 comprises a ring-nut 41 mounted on the supporting structure 21 and having a plurality of teeth 42, angularly offset with respect to each other and facing towards the anti-rotation member 16, so that the clamping pin 29 is normally maintained, by the thrust applied by the helical spring 18, angularly blocked between the teeth 42 of the ring-nut 41. The ring-nut 41 is also provided with an axial through hole 43, which allows access from above to the terminal portion 28 of the slider 27.

The unclamping mechanism 12 comprises a tubular element 45, which is both rotatable around its own longitudinal axis, thanks to the electric motor 49 (FIGS. 1, 2 and 4), and also mobile axially thanks to an actuation mechanism 30, mounted on the fixed structure 44 of the mixing machine 40. The tubular element 45 is positioned so as to be coaxial with the screw 25 and the slider 27 of the anti-rotation member 16, when the rotary unit 15 is in the angular position for loading or unloading the container 13, shown in FIG. 1.

Moreover, the tubular element 45 comprises an unclamping terminal 46 able to be moved to an active unclamping condition, in which it is angularly coupled with the cap 24 so as to be able to thrust downwards the terminal portion 28 of the slider 27 against the action of the helical spring 18, and to move the slider 27 axially, thus de-constraining the clamping pin 29 from the teeth 42 of the ring-nut 41.

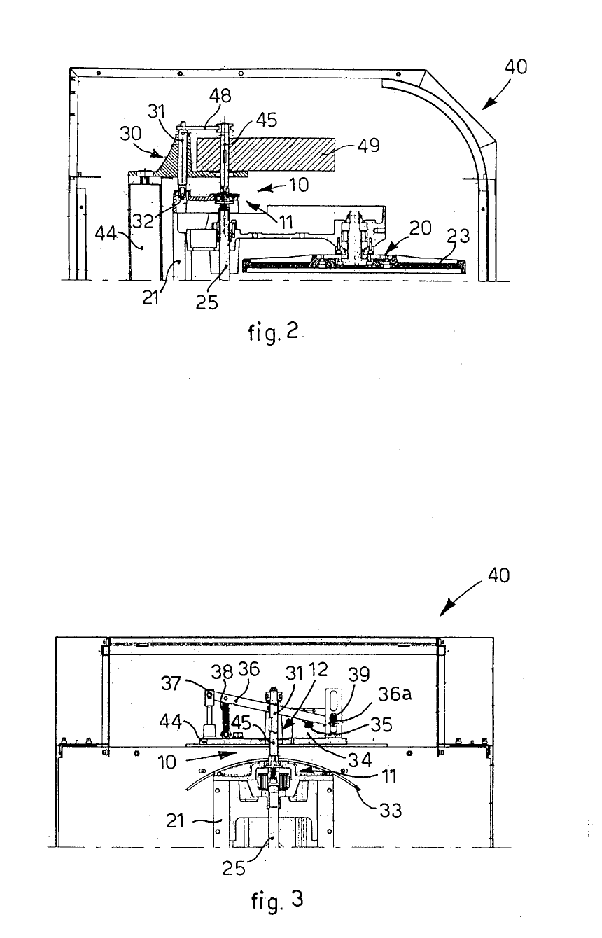

The actuation mechanism 30 (FIGS. 2, 3, 4, 5 and 6) comprises a positioning pin 31, mounted on the fixed structure 44 so as to be coaxial with a positioning cavity 32, made on the peripheral part of the supporting structure 21 of the rotary unit 15, when the latter is in the loading or unloading position. There is an arched plate 33, of a known type, on the supporting structure 21, astride the positioning cavity 32, which is able to promote the insertion of the positioning pin 31 into the positioning cavity 32.

The axial movement of the positioning pin 31 is commanded by a third electric motor 34, by means of a rod 35, which cooperates with a lever 36, which is pivoted on a fixed pin 37, is constantly drawn downwards by a traction spring 38, and is coupled with the positioning pin 31 in its intermediate part.

A second positioning sensor 39 is able to detect the presence of one end 36a of the lever 36, when the latter is in a determinate operating position shown in FIGS. 2 and 3.

The positioning pin 31 and the tubular element 45 are parallel to each other and are able to move together axially, because they are connected by a support 48, with respect to which the tubular element 45 can rotate around its longitudinal axis.

An electronic processor 50 (FIG. 9), of a known type, is able to control the three electric motors 14, 34 and 49, according to the electric signals arriving from the two sensors 26 and 39.

The anti-rotation device 10 as described heretofore functions as follows.

In the first operating condition, that is, the loading or unloading condition, of the container 13 in the mixing machine 40 (FIG. 1), the anti-rotation device 10 is in the clamped position, with the positioning pin 31 in the positioning cavity 32 of the supporting structure 21.

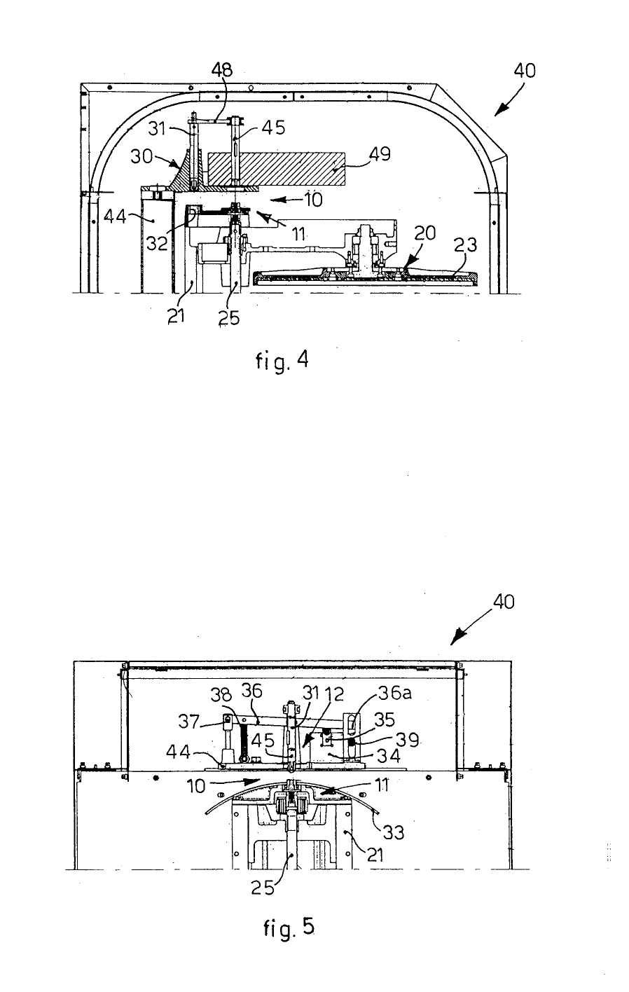

In this first operating condition the electronic processor 50 commands, in a known manner, the plates 22 and 23 to close by means of the electric motor 49 and to clamp the container 13 with respect to the supporting structure 21. When clamping is complete, the electric motor 34 is energized, so as to make the rod 35 rotate by 180° (FIG. 5) and in this way to take both the positioning pin 31 and the tubular element 45 upwards, completely releasing them from the rotary unit 15 (second operating condition shown in FIGS. 4, 5 and 7).

In the second operating condition, the electronic processor 50 commands, in a known manner, the rotary unit 15 to rotate, by means of the electric motor 14, so as to effect the mixing step.

When the mixing step of the container 13 is finished, according to a program memorized in the electronic processor 50, the electric motor 14 is decelerated until the angular speed of the rotary unit 15 decreases to about 8 rpm. As soon as the sensor 26 detects the passage of the supporting structure 21 from the angular loading or unloading position, shown in FIGS. 1 to 7, the electronic processor 50 commands the motor 34, which makes the rod 35 rotate, until the sensor 39 detects the presence of the end 36a of the lever 36. In particular, as the supporting structure 21 approaches the angular loading or unloading position, the arched plate 33 gradually lifts the positioning pin 31 and the lever 36 that is solid with it. Consequently, the sensor 39, which no longer detects, at least temporarily, the presence of the end 36a of the lever 36 because it is too low, causes a further reduction in the angular speed of the rotary unit 15. If the angular speed is not sufficient to take the rotary unit 15 to the loading or unloading position in a pre-determined time, the electronic processor 50 causes it to gradually increase.

Furthermore, if the tubular element 45, lowering itself together with the positioning pin 31, does not couple angularly with the cap 24 because there is a lack of angular coincidence between them, the sensor 36 is not actuated and the electronic processor 50 commands the electric motor 49 so that the tubular element 45 performs small rotations, in both directions, until there is perfect coupling and the sensor 36 is actuated.

The coupling of the tubular element 45 with the cap 24 determines the unclamping of the screw 25, which is therefore made to rotate by the motor 49, so that the clamping plates 22 and 23 are distanced from each other and the container 13 can be removed from the mixing machine 40.

It is clear, however, that modifications and/or additions of parts may be made to the anti-rotation device 10 as described heretofore, without departing from the field and scope of the present invention.

For example, it comes within the field of the present invention to provide that instead of the clamping pin 29 the anti-rotation member 16 comprises a ring-nut with teeth, or gear, of a size and shape corresponding with those of the ring-nut 41 of the reference member 17.

It also comes within the field of the present invention to provide that instead of the clamping pin 29 and the ring-nut 41, respective friction disks are provided which, through reciprocal friction, angularly constrain the screw 25 to the supporting structure 21.

It is also clear that, although the present invention has been described with reference to specific examples, a person of skill in the art shall certainly be able to achieve many other equivalent forms of anti-rotation device for a gripping member of a mixing machine for fluid products, contained in a container, having the characteristics as set forth in the claims and hence all coming within the field of protection defined thereby.

1-14. (canceled)

15. An anti-rotation device for a gripping member of a mixing machine able to mix fluid products contained in a closed container, wherein said mixing machine comprises a fixed structure and wherein said gripping member comprises at least a supporting structure rotatable with respect to said fixed structure and on which two gripping elements are mounted, able to be selectively moved nearer to or farther from each other by means of screw means, in order to determine the temporary clamping of said container with respect to said supporting structure, the anti-rotation device comprising clamping means associated coaxially with said screw means in order to keep said screw means temporarily constrained angularly with respect to said supporting structure of said gripping member, and unclamping means mounted on said fixed structure and able to be selectively moved, in order to cooperate with said screw means, so as to de-activate the action of said clamping means and to allow the angular movement of said screw means with respect to said supporting structure, and actuation means able to automatically and selectively command both said unclamping means and also said clamping means.

16. The anti-rotation device as in claim 15, wherein said unclamping means is able to be both constrained angularly to said screw means, and also to be connected to a corresponding drive member, so as to transmit the rotational motion of said drive member to said screw means in the unclamped condition thereof.

17. The anti-rotation device as in claim 15, wherein said clamping means comprises an anti-rotation member mounted coaxial on said screw means, a reference member mounted fixed on said supporting structure and at least an elastic element able to keep said anti-rotation member in cooperation with said reference member, in order to angularly constrain the individual rotation of said screw means.

18. The anti-rotation device as in claim 17, wherein said anti-rotation member comprises a hollow cap fixed angularly to said screw means, a slider disposed sliding axially and constrained angularly inside said cap, and a clamping pin mounted transversely on the slider and having respective ends protruding sideways from said cap, and wherein said slider comprises a terminal portion facing towards the outside through an upper opening of said cap, and able to be selectively thrust by said unclamping means.

19. The anti-rotation device as in claim 18, wherein said elastic element is disposed inside said cap in an intermediate position between said slider and said screw means.

20. The anti-rotation device as in claim 18, wherein said reference member comprises a ring-nut mounted on said supporting structure and provided with a plurality of teeth angularly offset with respect to each other and facing towards said anti-rotation member.

21. The anti-rotation device as in claims 20, wherein said clamping pin is kept in cooperation with said teeth of said ring-nut.

22. The anti-rotation device as in claim 18, wherein said unclamping means comprises a tubular element mounted sliding with respect to said fixed structure and positioned substantially coaxial with said screw means and said anti-rotation member.

23. The anti-rotation device as in claim 22, wherein said tubular element comprises an unclamping terminal able to be moved to an active unclamping condition, in which the tubular element is constrained angularly to said cap and thrusts said terminal portion of said slider so as to overcome the force of said elastic means.

24. The anti-rotation device as in claim 23, wherein said tubular element also comprises kinematic connection means able to selectively connect said unclamping means to a drive member.

25. The anti-rotation device as in claim 15, wherein said actuation means comprises a substantially mechanical actuation mechanism, electrically commanded by means of at least an electric motor.

26. The anti-rotation device as in claim 25, wherein said actuation mechanism is able to be controlled by an electronic processor.

27. The anti-rotation device as in claim 15, wherein said unclamping means is able to be selectively moved by means of an actuation mechanism, able to clamp said gripping member at the end of the mixing of said fluid products.
